(19) United States
(12) Patent Application Publication
(10) Pub. No.: US 2007/0188163 A1
(43) Pub. Date: Aug. 16, 2007

(54) Sensor device

(75) Inventors: Manfred Jagiella, Notzingen (DE); Winfried Kunzweiler, Ebersbach-Buenzwangen (DE); Urs Matter, Solothurn (CH); Simon Mahler, Bern (CH)

Correspondence Address: Lipsitz & McAllister, LLC, 755 MAIN STREET, MONROE, CT, 06468, US

(73) Assignee: BALLUFF GmbH, Neuhausen (DE)

(21) Appl. No.: 11/656,889

(22) Filed: Jan. 22, 2007

(30) Foreign Application Priority Data
Jan. 24, 2006 (DE) 10 2006 003 993.9

(51) Int. Cl. G01B 7/14

(52) U.S. Cl. 324/207.15; 324/207.26

(57) ABSTRACT

A sensor device is suggested, comprising a sensor module with a housing, with at least one sensor element which is arranged in the housing, at least one active sensor face and a sensor module connection device and a holding module for holding the sensor module, a holding module connection device which is adapted to the sensor module connection device, wherein the sensor module can be fixed to the holding module via the sensor module connection device and the holding module connection device and an electrical connection can be made available between the sensor module and the holding module, and wherein the holding module is provided for the fixing to an application or is part of an application, the supply of energy to the sensor module is brought about via the holding module and the coupling out of signals is brought about via the holding module.

The present disclosure relates to the subject matter disclosed in German application number 10 2006 003 993.9 of Jan. 24, 2006, which is incorporated herein by reference in its entirety and for all purposes.

### BACKGROUND OF THE INVENTION

The invention relates to a sensor device.

The invention relates, in addition, to an inductive sensor device, comprising a coil as sensor element and a housing, in which the coil is arranged, wherein the housing has a first housing end side, by means of which an active sensor face is determined, and an oppositely located second housing end side.

The invention relates, in addition, to an inductive sensor device with a sensor unit, comprising a housing and at least one inductive sensor element which is arranged in the housing.

### SUMMARY OF THE INVENTION

In accordance with the invention, a sensor device is provided which can be used universally.

In accordance with an embodiment of the invention, a sensor module with a housing is provided, at least one sensor element which is arranged in the housing, at least one active sensor face and a sensor module connection device is provided and a holding module for holding the sensor module and having a holding module connection device which is adapted to the sensor module connection device is provided, wherein the sensor module can be fixed to the holding module via the sensor module connection device and the holding module connection device and an electrical connection can be made available between the sensor module and the holding module, and wherein the holding module is provided for the fixing to an application or is part of an application, the supply of power to the sensor module is brought about via the holding module and the coupling out of signals is brought about via the holding module.

In accordance with the invention, the sensor device comprises (at least) two parts, namely a sensor module and a holding module. The sensor module forms the detection unit of the sensor device. The holding module forms the “supply unit” for the sensor module. The mechanical fixing to an application is brought about via the holding module and the provision of electrical power for operation of the sensor module and the coupling out of sensor signals is brought about via the holding module.

The holding module may be produced in a simple manner. It need not be provided with an electronic circuit. For example, it comprises a mounting device for the purpose of fixing it to an application. In addition, an electrical connection to an external power supply and a signal line of the holding module connection device must be provided for. The sensor module can also be fixed mechanically via the holding module connection device.

In practice, different requirements are to be met with respect to the mounting of a sensor device, depending on the application. As a result of the solution according to the invention, one type of sensor module or a small number of sensor module types may be made available, wherein the variability with respect to the fixability to an application is brought about via the holding module. A holding module is designed in accordance with the application requirements, wherein the sensor module or the small number of sensor modules can be used for all applications. The sensor modules may be produced in a simple and inexpensive manner and also stored. Furthermore, the sensor modules may also be of a compact design and have small dimensions.

A sensor module can, in particular, be connected to a holding module so as to be detachable. As a result, an exchange of the sensor module is facilitated in a simple manner without the holding module on an application needing to be exchanged.

The sensor module connection device and the holding module connection device are designed, in particular, such that the sensor module can be plugged into the holding module. As a result, a simple connectability between the sensor module and the holding module results, by means of which an electrical connection is provided for (with respect to supply of electrical power and coupling out of signals) as well as a mechanical connection for the fixing of the sensor module to the holding module. As a result, a detachable connection may be realized in a simple manner and so a sensor module can also be exchanged in a simple manner.

It is particularly favorable when the sensor module connection device has at least one pin and the holding module connection device has an adapted pin receiving means. A connection between pin and pin receiving means may be provided in a simple manner. A mechanically stable connection may be achieved, by means of which an electrical connection can also be provided at the same time.

For the same reason, it is favorable when the holding module connection device has at least one pin and the sensor module connection device has at least one adapted pin receiving means.

It is particularly advantageous when the at least one pin is designed as a contact pin. A sensor module may then be plugged into a holding module in a simple manner, wherein an electrical connection and a mechanical connection are automatically provided for.

At least two pins are provided, in particular. One pin serves the purpose of transmitting sensor signals to the holding module. One or two additional pins serve the purpose of supplying the electrical power. (In the case of a two pin solution, the transmission of sensor signals and the supply of power can fall to the same pin). A fourth pin can also be provided, for example, for a monitoring signal. In principle, it is possible for the number of pin receiving means to correspond exactly to the number of pins. It is, for example, also possible for the number of pin receiving means to be greater than the minimum number of pins. As a result, all types of sensor module may be fixed to the corresponding holding module. For example, a holding module has four pin receiving means. As a result, sensor modules with two or three contact module; sensor modules with internal monitoring or without internal monitoring may, for example, be fixed to the holding module.

It is favorable when the holding module has a mounting device for fixing it to an application. As a result, the holding module may be positioned on and fixed to an application mechanically.

In one embodiment, the mounting device comprises at least one continuous recess. The continuous recess is present, for example, in the form of a bore. As a result, the mounting device and, with it, the holding module may be fixed to the application, for example, via screws.

A direction of orientation of the at least one recess may be parallel and/or transverse (in particular, at right angles) to a plug-in direction of the sensor module onto the holding module. Depending on the application, different alignments of the sensor module and also of active faces of the sensor module with respect to the application may be realized.

It is, for example, also possible for the mounting device to comprise a thread. As a result, the holding module may be screwed to an application or clamped to an application via one or more nuts which are guided on the thread.

In one embodiment, the mounting device comprises a clampable element and/or at least one clamping element. As a result, the mounting device may be clamped to an application or itself makes clamping elements available in manner.

It may be provided for the mounting device to comprise a bar. It is possible to engage around such a bar at least partially in order to fix it to an application. As a result, the holding module may be fixed, for example, to a stand arrangement in a simple manner.

It may also be provided for the holding module to be designed in several parts, wherein a first part can be fixed to an application and a second part can be fixed to the first part. The first part is, for example, screwed to the application. The second part (which bears, for example, the holding module connection device) is then fixed to the first part. A dovetail guide is, for example, provided.

It may be provided for the at least one active sensor face to be parallel to a mounting side of the holding module or transverse (in particular, at right angles) to a mounting side of the holding module. Depending on the application, the field of view of the sensor device may be adjusted as a result. The mounting side of the holding module is that side which faces the application. For example, the mounting side abuts on the application when the holding module is fixed on the application.

It is possible for a plug-in direction of the sensor module onto the holding module to be transverse (in particular, at right angles) or parallel to a mounting side of the holding module on an application. Depending on the application, an optimum mountability with an optimized field of view of the sensor device may be ensured as a result.

It may be provided for the holding module and the sensor module to be designed such that the sensor module, when it is held on the holding module, projects beyond an outer surface of the holding module, is flush with an outer surface of the holding module or is set back in relation to it. Depending on the application, the optimum positioning of the sensor module with its at least one active face may be brought about as a result. For example, it may be advantageous, in order to avoid damage to the sensor module, when this is flush with an outer surface or is recessed. For other applications, the field of view may be optimized when the sensor module projects beyond the outer surface.

It is favorable when the holding module has a signal connection and an electrical connection. It may, in addition, be provided for the holding module to have a monitoring signal connection. These connections may be combined so that they can be guided to the holding module via a single cable, wherein individual wires are then guided to the holding module connection device in order to provide for the electrical connection.

For example, a cable is guided away from the holding module. As a result, a reliable power supply connection between the holding module and the cable can be achieved in a simple manner.

It is also possible for the holding module to be a printed circuit board. The sensor element may then be arranged on the printed circuit board in a simple manner.

It is particularly advantageous when a height of the housing of the sensor module is at the most twice as great as the greatest diameter at right angles to the height. For example, the height is smaller than the greatest diameter at right angles to the height. As a result, a sensor module can be made available which is of a knob-like design. Such a sensor module with corresponding, small dimensions may be used for a large number of applications.

For example, the housing of the sensor module is cylindrical or of a parallelepiped design. As a result, a compact, outer shape is achieved.

It is, in addition, favorable when the at least one active sensor face is determined by a housing side of the sensor module. As a result, an easy positionability or alignability of the sensor module with respect to an application results.

For example, the at least one active sensor face is determined by a housing side located opposite the sensor module connection device or the at least one active sensor face is located transversely to a housing side, on which the sensor module connection device is arranged. Every alignment of the active sensor face may be realized in a simple manner as a result of the provision of a sensor module and a holding module.

The at least one sensor element is, in particular, an inductive sensor element (a coil) or capacitive sensor element. As a result, an inductive proximity sensor or capacitive proximity sensor may be realized. The coil is, for example, attached to a support or soldered to it or arranged on the support as a print coil and, in particular, a flat coil.

The at least one sensor element is favorably a coil, with which a coil core, such as, for example, a ferrite core, is associated. As a result, the sensor effect of the sensor element is optimized.

The sensor device is favorably designed as a distance sensor device or position sensor device or proximity sensor device or tracer device. In this respect, analog signals and/or digital signals (switching signals) may be made available with respect to the proximity or switching signals with respect to the presence/absence of an object.

It is favorable when the sensor module has a support which is oriented essentially parallel to at least one sensor element. When the sensor element is a coil, the support is preferably oriented parallel to a coil surface, i.e., a coil axis is oriented transversely and, in particular, at right angles to the support. As a result, a compact sensor module may be realized.

The at least one sensor element is favorably plugged into the support or soldered to it or imprinted on it. As a result, the corresponding sensor module may be produced in a simple manner and, in particular, produced by machines in an automated manner.

It is favorable when a space is formed between the at least one sensor element and the support. Components of the sensor module may be accommodated in the space. As a result, a compact construction may be realized

One or several electronic components are, in particular, arranged in the space in order to bring about a compact construction.

It is favorable when the support is arranged parallel to a housing side of the housing of the sensor module. The housing side is, in particular, a housing end side. As a result, a compact construction may be realized.

It is particularly advantageous when the support is arranged parallel to an active sensor face. This results in a compact construction. For example, a sensor module may be of a knob-like design.

It is favorable when contact pins are arranged on a support and/or on the housing. As a result, a sensor module connection device may be realized in a simple manner and a sensor module may be fixed on a holding module in a simple manner.

In accordance with the invention, an inductive sensor is provided for which a signal connection and a power supply connection are arranged on a housing lateral side between the first housing end side and the second housing end side.

In accordance with the invention, a cable may be guided away laterally from the sensor unit. This may be advantageous for applications, with which no space is available behind the second housing end side.

Additional, advantageous embodiments of this sensor device according to the invention have already been explained above.

In accordance with an embodiment of the invention, a height of the housing is at the most twice as great as the greatest diameter at right angles to the height.

As a result, a sensor unit may be formed which is of a compact construction. A sensor unit may be realized which is shaped like a knob.

For example, the height of the housing is at the most twice as great as the greatest diameter at right angles to the height.

It may be provided for a plug element to be arranged on the support which is connected, in particular, rigidly to the support. The plug element may, in principle, be designed as a holding module. As a result, at least one sensor element may be positioned on the support, wherein the plug element is seated on the same support at the same time.

The plug element has, in particular, contact pins. For example, four contact pins are provided. As a result, an electrical contact may be provided in a simple manner.

In one embodiment, the at least one inductive element is seated on one side of the support and electronic components are arranged on the oppositely located side of the support. For example, electronic components are realized in a chin. The at least one inductive element is designed, in particular, as a print coil. As a result, an inductive sensor device with small height dimensions may be made available.

Additional, advantageous embodiments have likewise already been described above.

The following description of preferred embodiments serves to explain the invention in greater detail in conjunction with the drawings.

### BRIEF DESCRIPTION OF THE DRAWINGS

FIG. 1 shows a schematic lateral sectional illustration of a first embodiment of a sensor device in accordance with the invention/a sensor module according to the invention;

FIG. 2 shows an exploded illustration of the sensor device/the sensor module according to FIG. 1;

FIG. 3 shows a second embodiment of a sensor module;

FIG. 4 shows a third embodiment of a sensor module;

FIG. 5 shows a fourth embodiment of a sensor module;

FIG. 6 shows a first embodiment of a holding module;

FIG. 7 shows a second embodiment of a holding module;

FIG. 8 shows a third embodiment of a holding module;

FIG. 9 shows a fourth embodiment of a holding module;

FIG. 10 shows fifth embodiment of a holding module;

FIG. 11 shows a sixth embodiment of a holding module;

FIG. 12 shows a seventh embodiment of a holding module;

FIG. 13 shows an eighth embodiment of a holding module with a sensor module fixed in place;

FIG. 14 shows a ninth embodiment of a holding module;

FIG. 15 shows a tenth embodiment of a holding module;

FIG. 16 shows an eleventh embodiment of a holding module;

FIG. 17 shows a twelfth embodiment of a holding module;

FIG. 18 shows a schematic illustration of a sensor device according to the invention fixed in place on a profiled support;

FIG. 19 (a) and (b) shows a thirteenth embodiment of a sensor device according to the invention;

FIG. 20 shows a fourteenth embodiment of a sensor device according to the invention;

FIG. 21 shows a fifteenth embodiment of a sensor device according to the invention; and

FIG. 22 shows a sixteenth embodiment of a sensor device according to the invention.

### DETAILED DESCRIPTION OF THE INVENTION

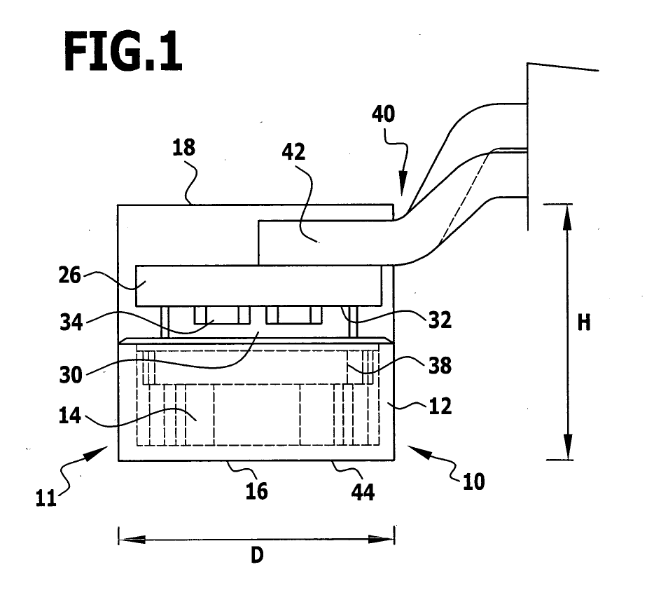

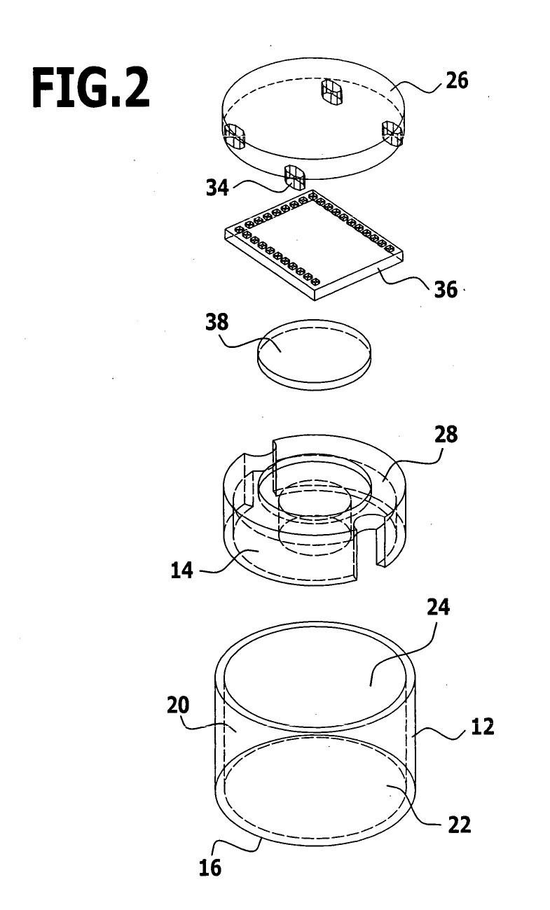

A first embodiment of a sensor device in accordance with the invention, which is shown in FIGS. 1 and 2 and designated as 10, comprises a sensor unit 11 with a housing 12, in which (at least one) sensor element 14 is arranged. The sensor element 14 is, in particular, a coil. The sensor device 10 is then, in particular, an inductive sensor device. It is designed, for example, as a distance sensor or proximity sensor or position sensor. In this respect, an analog distance determination or proximity determination or position determination may take place or one or several switching points may be generated. In the latter case, the sensor device 10 is a distance switch or proximity switch or position switch. The sensor device 10 may also be designed, for example, as a tracer for determining the presence/absence of an object. It may be designed, for example, as a 2-wire switch or 3-wire switch.

The housing 12 has a first housing end side 16. A second housing end side 18 is provided, located opposite the first housing end side 16.

In the embodiment shown in FIGS. 1 and 2, a side wall 20 is seated on the first housing end side 16 in an integral manner and this forms a housing lateral side 22 which points outwardly. The housing 12 has a space 24 for receiving the sensor element 14.

The sensor element 14 is arranged on a support 26 which is positioned within the housing 12 between the first housing end side 16 and the second housing end side 18.

When the sensor element 14 is an inductive element, i.e., a coil, a coil core 28, such as, for example, a ferrite core, is associated with it in one embodiment. The sensor element 14 with the coil core 28 is arranged so as to be in spaced relationship to the support 26 so that a space 30 is formed between the support 26 and the sensor element 14 with the coil core 28. The spaced arrangement of the sensor element 14 in relation to the support 26 and, in particular, in relation to a support surface 32 may be brought about, for example, in that spacer elements 34 are seated on the support 26, wherein the sensor element 14 with the coil core 28 is, on the other hand, seated on the spacer elements 34. The spacer elements 34 may serve at the same time as electrical connection elements for the electrical connection of electronic components on the support 26 and the sensor element 14.

One or more electronic components 36 of the sensor device 10 can be positioned in the space 30.

It may be provided for an intermediate element 38 to be seated between the electronic component or components 36 and the sensor element 14 with the coil core 28. This intermediate element is, for example, of a disk-shaped design and is seated in a corresponding recess of the coil core 28. The intermediate element 38 serves, for example, as a screening element between the sensor element 14 and the electronic component or components 36.

A height H of the housing 12 is at the most twice as great as the diameter D of the housing 12 at right angles to this height H. The sensor device 10 is of a knob-like design as a result. It has small external measurements.

In the case of the embodiment shown in FIGS. 1 and 2, the housing 12 has a cylindrical shape. Other shapes are, however, also possible for the housing.

The sensor device 10 has a connection device 40 which is arranged to the side on the housing 12. The connection device 40 is arranged, in particular, between the housing end side 18 and the support 26 on the side wall 20. The connection device 40 is, in particular, an electrical connection device. For example, electrical cables 42 are guided to the housing 12 in order to supply power to the sensor device 10 as well as in order to couple signals out. These cables 42 are, in particular, soldered to corresponding contact elements which are arranged, for example, on the support 26.

The sensor device 10 has an active sensor face 44 which is determined by the first housing end side 16 in the embodiment according to FIGS. 1 and 2. The sensor device 10 has a front field of view associated with it, in which an active detection can take place, wherein the field of view is defined by the active sensor face 44.

The support 26 and the sensor element 14 are oriented parallel to one another. When the sensor element 14 is a coil, the coil axis is then aligned at right angles to the support 26. The support 26 is parallel to the active sensor face 44. As a result, a space-saving, compact construction may be achieved for the sensor device 10.

The sensor unit 11 may be designed, in particular, as a sensor module for fixing to a holding module, as will be described in greater detail further on, when the connection device 40 is of a corresponding design and has, in particular, contact pins. It may also be designed as a “stand-alone” sensor unit.

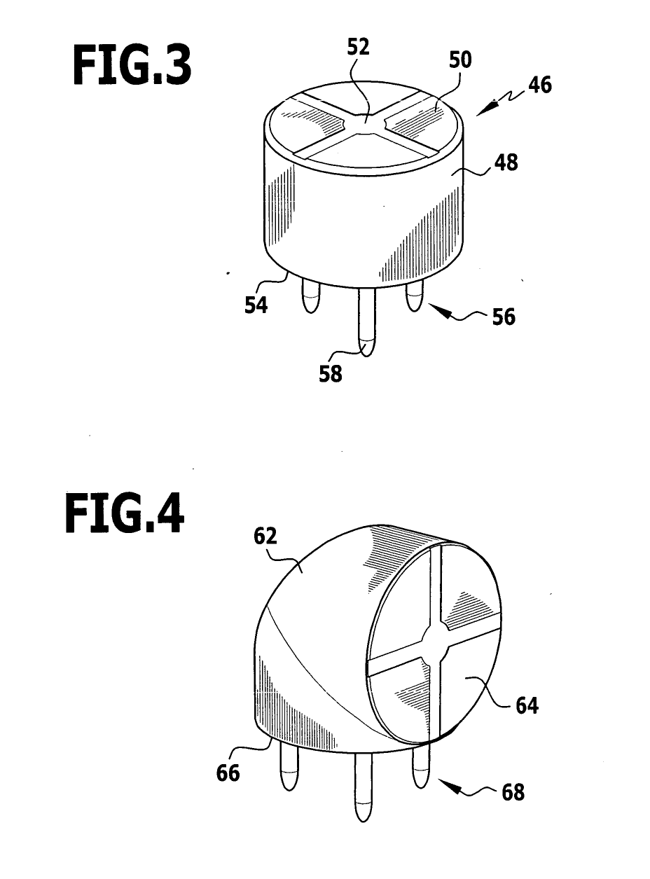

In a further embodiment of a sensor device according to the invention, a sensor module 46 is provided, as shown in FIG. 3, and this has a housing 48, in which a sensor element and, in particular, a coil is arranged. The arrangement in the housing is, in principle, the same as that described above on the basis of the sensor unit 11.

The housing 48 has a first housing end side 50 which determines an active sensor face 52. A sensor module connection device 56 is arranged on a second housing end side 54 located opposite the first housing end side 50.

The sensor module connection device 56 comprises a plurality of pins 58 which are designed as contact pins. The contact pins 58 are rigid. The sensor module 46 can be plugged via these pins into corresponding pin receiving means of a holding module in order to provide for a mechanical and electrical connection between the sensor module 46 and a holding module.

The contact pins 58 narrow at their lower end in order to facilitate their insertion into corresponding pin receiving means.

Three contact pins 58 are, for example, provided; one contact pin serves the purpose of coupling out signals and the two other contact pins serve the purpose of supplying electrical power. It is, for example, also possible for additional contact pins to be provided. For example, an additional contact pin can serve the purpose of coupling out a sensor module monitoring signal.

In the case of the sensor module 46, the active sensor face 52 and the sensor module connection device 56 are located opposite one another.

The housing 48 is of a cylindrical design.

It may also be provided, as shown by way of example on the basis of a third embodiment of a sensor module 60 (FIG. 4), for a corresponding housing 62 to be designed such that an active face 64 and a housing end side 66, on which a sensor module connection device 68 with contact pins is arranged, to be located transversely and, in particular, at right angles to one another.

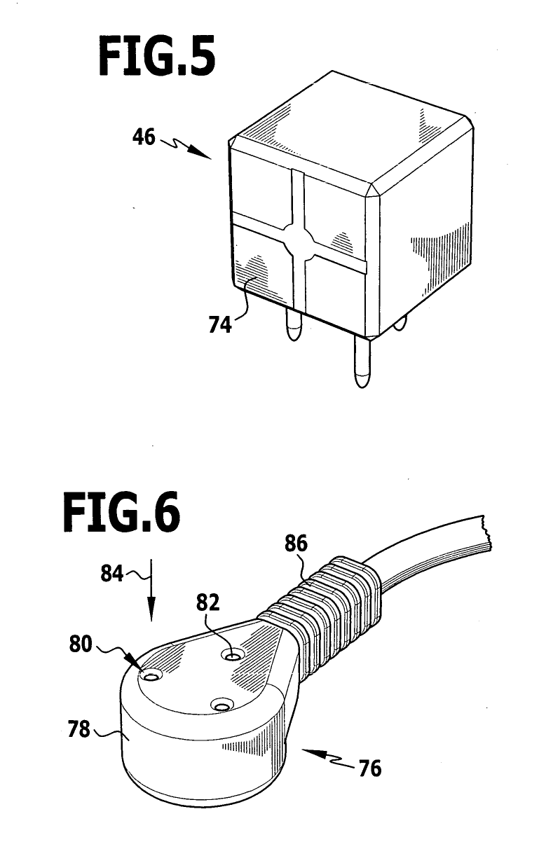

In a fourth embodiment of a sensor module, which is shown in FIG. 5 and designated as 70, a housing 72 is provided which is parallelepiped in design. In the case of the embodiment shown, an active sensor face 74 is arranged, in a similar way to the sensor module 60, transversely to a housing side, on which a sensor module connection device is, again, seated. An oppositely located arrangement is also possible.

In order to fix a sensor module to an application, a holding module is provided. The corresponding sensor module is supplied with electrical power via the holding module. Furthermore, the signals are coupled out at the corresponding sensor device via the holding module. The coupling out of sensor module monitoring signals by the holding module can also be provided. A corresponding holding module has for this purpose an electrical power supply connection and a signal coupling out connection. When sensor monitoring is provided, the holding module then also has a corresponding monitoring signal outlet connection.

As a result of the separation between sensor module and holding module, an adaptation to special applications is possible in a simple manner. The adaptation to the application is brought about via the holding module. Corresponding holding modules are made available, via which the mechanical fixability to the application can, in particular, be optimized. A great variability can be present in the case of the design of holding modules. Only a small number of variations of sensor modules are made available; in the extreme case, only a single type of sensor module is made available. Nevertheless, on account of the separation into sensor module and holding module a broad variability of use can be achieved. The sensor modules may be produced in a simple and inexpensive manner and also kept in supply since the variability in this case is limited.

A first embodiment of a holding module, which is shown in FIG. 6 and designated as 76, comprises a support 78, on which a holding module connection device 80 is arranged. This comprises pin receiving means 82 which are adapted to corresponding contact pins of the sensor module, for example, the contact pins 58 of the sensor module 46. For example, three or four pin receiving means 82 are provided.

A holding module has, for example, four pin receiving means which are designed such that a sensor module with only three contact pins can also be fixed in place. When a sensor module has no contact pin for a monitoring outlet, there is also no connection.

The corresponding sensor module (for example, the sensor module 46) can be plugged into the holding module in a plug-in direction 84. A sensor module 46 plugged into the holding module 76 is held on the holding module 76, i.e., fixed in place mechanically. Furthermore, an electrical contact is made.

The holding module 76 has a connection 86 for the coupling out of signals and the supply of electrical power. For example, a corresponding cable with connection wires is arranged on the holding module 76, wherein the connection wires are guided to the pin receiving means 82.

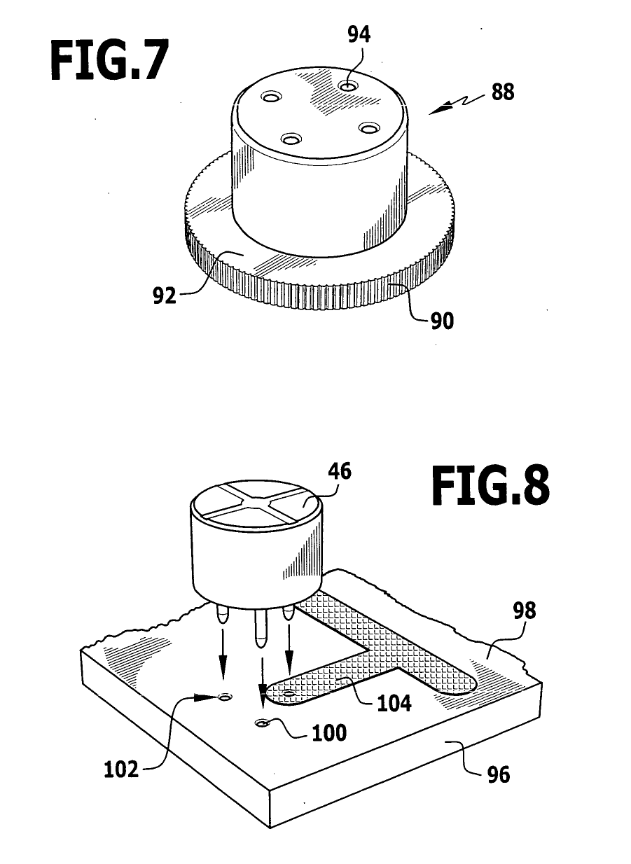

A holding module has a mounting device. In the case of a holding module which is shown in FIG. 7 and designated as 88, a mounting device 90 is provided which is designed as a nut 92. The holding module 88 can be screwed onto an application via the nut 92.

In the embodiment shown, the holding module 88 has four pin receiving means 94 for four corresponding contact pins of a sensor module.

It is also possible for a holding module 96, as shown in FIG. 8, to itself be part of an application. For example, the holding module is formed on or by a printed circuit board 98. The printed circuit board 98 is provided with pin receiving means 100, wherein a sensor module 46 can be plugged into the printed circuit board 98 via the pin receiving means. A corresponding holding module connection device 102 of the printed circuit board 98 is formed by the pin receiving means 100.

Corresponding conductor paths 104 are guided to the pin receiving means 100 on the printed circuit board in order to facilitate the supply of electrical power to the sensor module 46 via the printed circuit board 98 as well as be able to take away sensor signals supplied from the sensor module 46 for further processing.

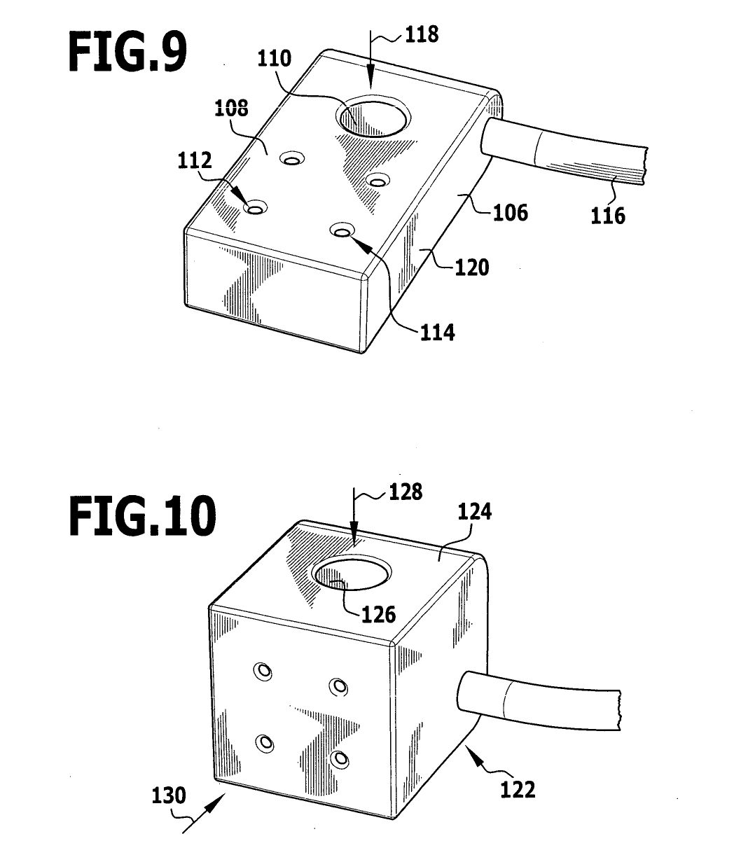

A fourth embodiment of a holding module, which is shown in FIG. 9 and designated as 106, comprises a support 108 which has (at least) one continuous recess 110. This continuous recess 110 is designed, for example, in the form of a bore. The support 108 and, as a result, the holding module 106 may be fixed to an application, for example, by way of screws via the recess 110.

Pin receiving means 114 for contact pins of a sensor module are formed on the support 108 in order to provide a holding module connection device 112. Wires of a cable 116 are guided to these pin receiving means. The cable 116 is connected to a support, for example, in the vicinity thereof.

In the embodiment shown in FIG. 9, the pin receiving means 114 are arranged parallel to the recess 110, i.e., the recess 110 has a direction of orientation 118 which is parallel to the plug-in direction of a sensor module onto the holding module 106.

The holding module 106 has a mounting side 120 which is defined via the support 108, faces the application during mounting and, in particular, abuts on the application. The mounting side 120 is oriented transversely and, in particular, at right angles to the plug-in direction.

When the sensor module 46 is plugged into the holding module 106, the active sensor face 52 is located essentially parallel to the mounting side 120.

It is also possible, as shown in a fifth embodiment of a holding module 122 (FIG. 10), for a support 124 to be provided, in which (at least) one continuous recess 126 is arranged which is oriented in a direction 128 which is transverse and, in particular, at right angles to a plug-in direction 130 of a sensor module.

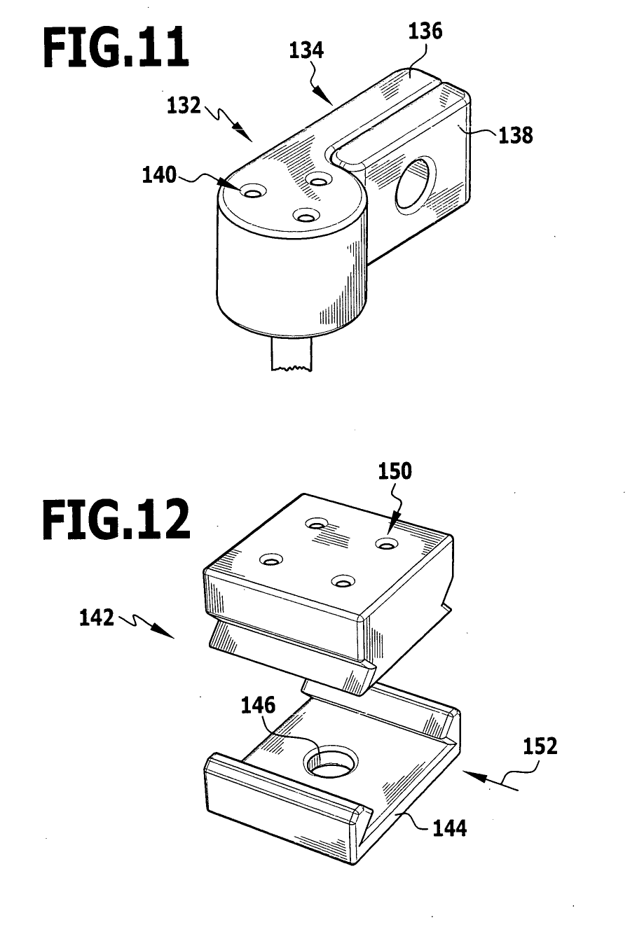

It is, for example, also possible for a holding module to be designed in several parts. In a sixth embodiment of a holding module, which is shown in FIG. 11 and designated as 132, a two-part support 134 is provided. The support 134 comprises a first part 136 and a second part 138. These are movable relative to one another so that the support 134 can be clamped to an application via the first part 136 and the second part 138. An element of the application may be clamped between the first part 136 and the second part 138 in order to fix the holding module 132 to the application as a result.

The holding module 132 has, on the other hand, a holding module connection device 140 in order to accommodate a sensor module and to fix this mechanically to the holding module and to provide for the electrical connection, i.e., to provide for the supply of electrical power to the sensor module and to provide for the coupling out of sensor signals via the holding module 132.

In a seventh embodiment of a holding module, which is shown in FIG. 12 and designated as 142, a first part 144 is provided which can be fixed to an application and, for example, can be screwed to it. For this purpose, the first part 144 has one or several continuous recesses 146. A second part 148 is provided which bears a holding module connection device with corresponding pin receiving means. The second part 148 can be fixed to the first part 144. For example, the second part 148 can be pushed onto the first part 144.

In the embodiment shown in FIG. 12, the second part 148 can be pushed onto the first part 144 in a direction 152 which is transverse to the plug-in direction of a sensor module onto the holding module 142.

For example, a dovetail guide is provided in order to guide the second part 148 on the first part 144 and to provide at least for a blocking of the movability parallel to the plug-in direction of the sensor module.

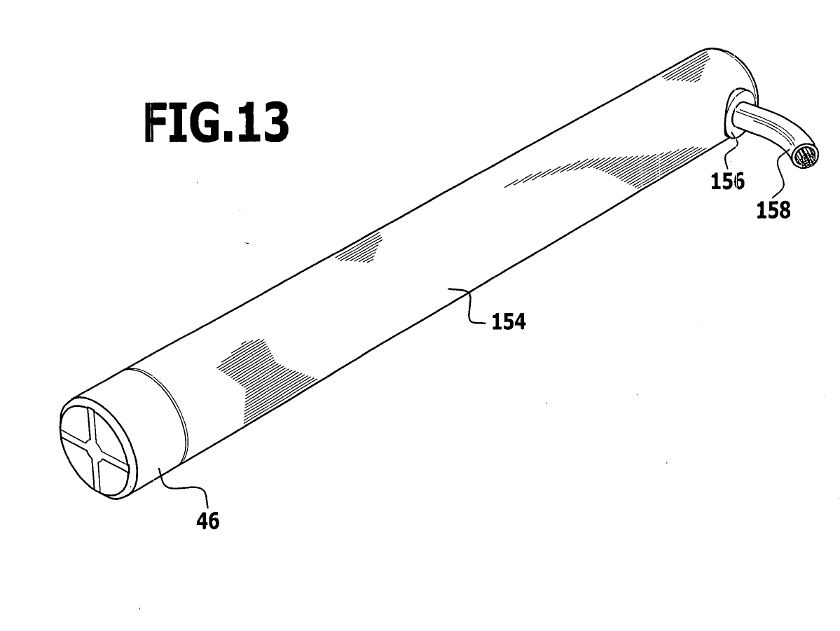

It is, for example, also possible for a holding module 154, as shown in FIG. 13, to be of a tubular design. A connection 156, at which a cable 158 is, for module 154. The holding module 154 may be clamped to a terminal.

For example, the holding module 154 is of a bar-like design. It may then be used as the bar of a stand.

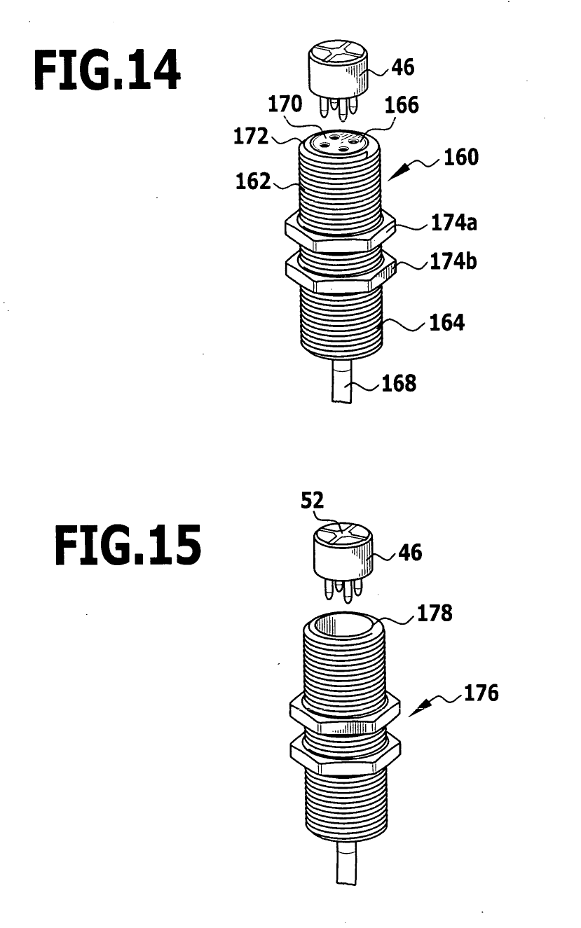

In a ninth embodiment of a holding module, which is shown in FIG. 14 and designated as 160, a support 162 is provided which has an external thread 164. A holding module connection device 166 is formed at or in the vicinity of one end of the support 162. A cable 168 leads at an oppositely located end to the support 162, wherein corresponding wires are connected to the holding module connection device 166.

The holding module connection device 166 has an element 170, in which pin receiving means are arranged. One outer surface of the element 170 is flush with an end side 172 of the support 162. A sensor module 46 plugged into the holding module 160 projects, as a result, beyond the end side 172 of the holding module 160.

The holding module 160 can be fixed to an application, for example, via clamping nuts 174a, 174b which are guided on the external thread 164.

In a further embodiment of a holding module, which is shown in FIG. 15 and designated as 176, a support is, again, provided, which is, in principle, of the same design as the support 162. However, the element corresponding to the element 170, in which pin receiving means are formed, is set back in relation to an end side 178 of the support. The element is set back, in particular, to such an extent that the sensor 46 may be fixed to the holding module 176 with its active face 52 flush with the end side 178 of the support 178.

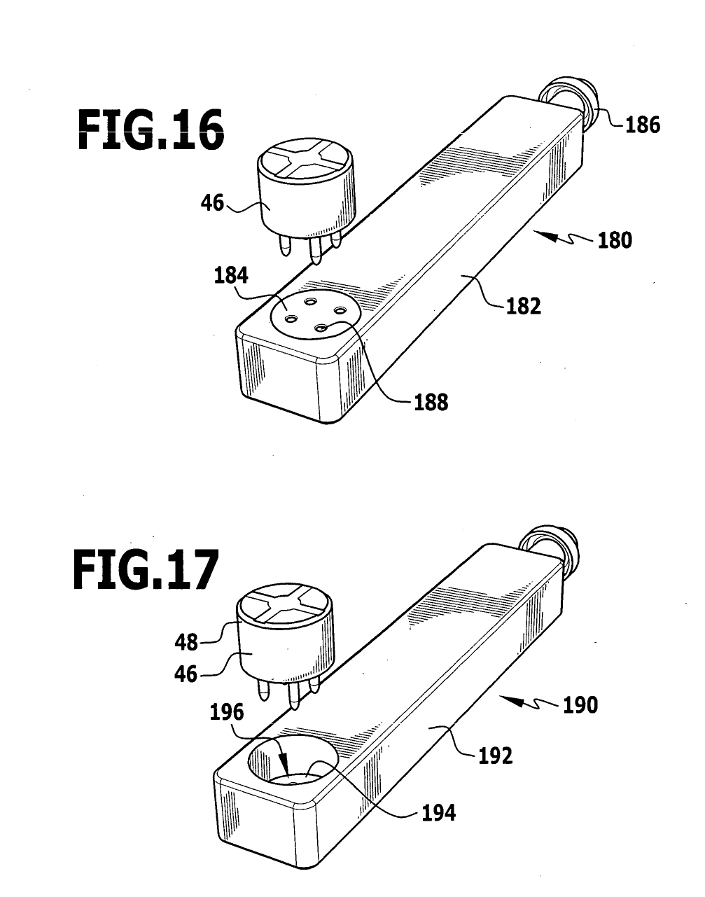

In a further embodiment of a holding module, which is shown in FIG. 16 and designated as 180, a holding module connection device 184 is formed on a support 182 designed, for example, in a parallelepiped shape. A sensor module 46 can be fixed mechanically to this connection device.

A connection 186 for the supply of electrical power and the coupling out of signals is arranged at one end of the support 182.

An upper end of pin receiving means 188 of the holding module connection device 184 is flush with an outer surface of the support 182 or at the most set back slightly.

In a further embodiment of a holding module, which is shown in FIG. 17 and designated as 190, the support is, in principle, of the same design as the holding module 180. However, the corresponding support 192 has a recess 194 which is adapted to the shape of a sensor module and in which the holding module connection device 196 is arranged.

The height of the recess 194 corresponds, in particular, to the height of the housing 48, for example, of the sensor module 46. As a result, the sensor module 46 may be arranged on the holding module 190 flush with an outer surface of the support 192 or in a recessed manner.

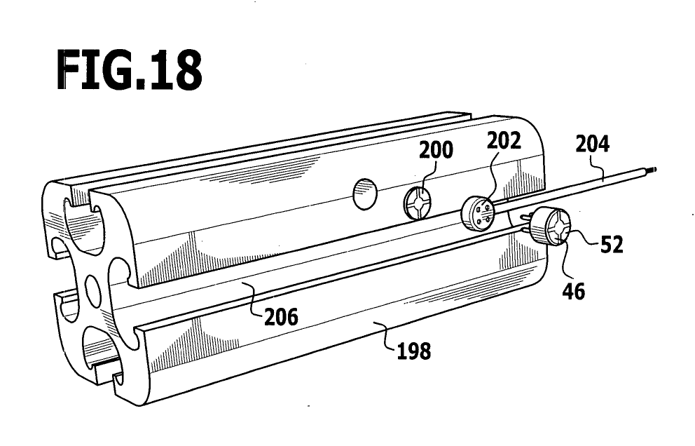

A sensor device according to the invention may be arranged, for example, on a profiled support 198 (FIG. 18). For this purpose, the profiled support is provided with a corresponding recess 200, in which a holding module 202 is positioned. A cable 204, which is coupled to the holding module 202, is guided, for example, in a groove 206.

A sensor module 46 is fixed to the holding module 202 which is seated in the recess 200. As a result, it is possible, for example, for an active sensor face 52 of the sensor module 46 to be flush with an outer surface of the profiled support 198 or be set back.

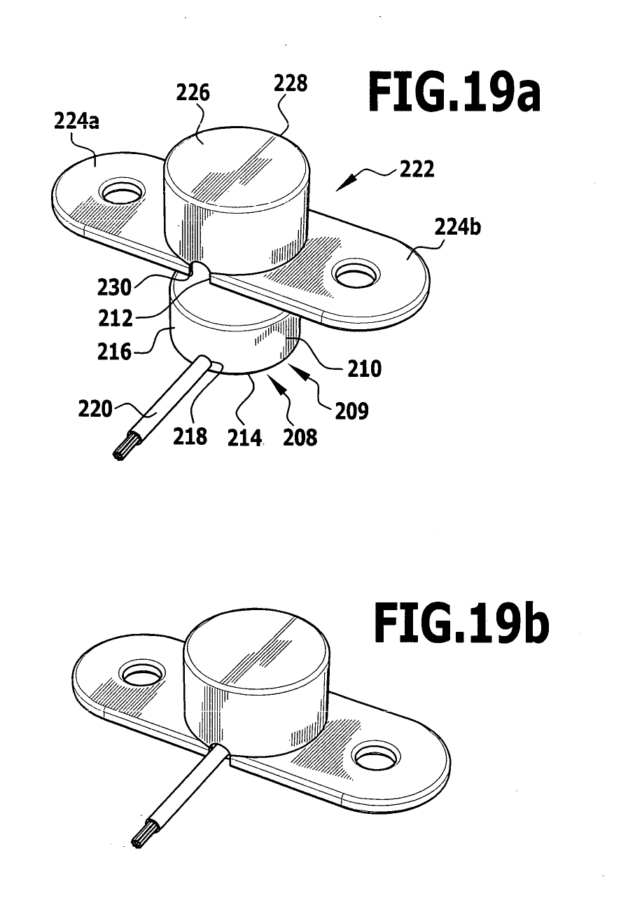

In a further embodiment of a sensor device according to the invention, which is shown in FIGS. 19(a) and 19(b) and designated as 208, a sensor unit 209 is provided with a housing 210 which is in principle, of the same design as the housing 12. The arrangement of components within the housing 210 is likewise, in principle, designed in the same way as that discussed in conjunction with FIGS. 1 and 2. The housing 210 has a first housing end side 212 and a second housing end side 214 located opposite. The housing 210 is closed via one or several housing lateral sides 216 which are located between the first housing end side 212 and the second housing end side 214.

A connection 218 is arranged on the (or one) housing lateral side 216. For example, a cable 220 is guided to the connection 218 and fixed relative to the housing 210.

As a result, the cable 220 does not exit at the first housing end side 212 and the second housing end side 214 but rather from the side. This can be advantageous for certain applications.

For example, the sensor device 208 comprises a holder 222, via which it is possible to fix it to an application. The holder 222 has, for example, flanges 224a, 224b, via which the holder 222 can be screwed to an application.

In the embodiment shown, the holder 222 comprises a receiving area 226 which is formed in a housing 228 open on one side. The receiving area serves to accommodate the housing 210, in which the sensor element is, again, arranged. The housing 210 with the lateral connection 218 (on which a cable 220 can be seated) may be inserted into the housing 228 from the open side.

The housing 228 has a recess 230 for the cable feed through.

The holder 222 with the housing 210 inserted into the housing 228 may be placed onto an application, as shown in FIG. 19(b). The outward movement of the housing 210 downwards is then blocked.

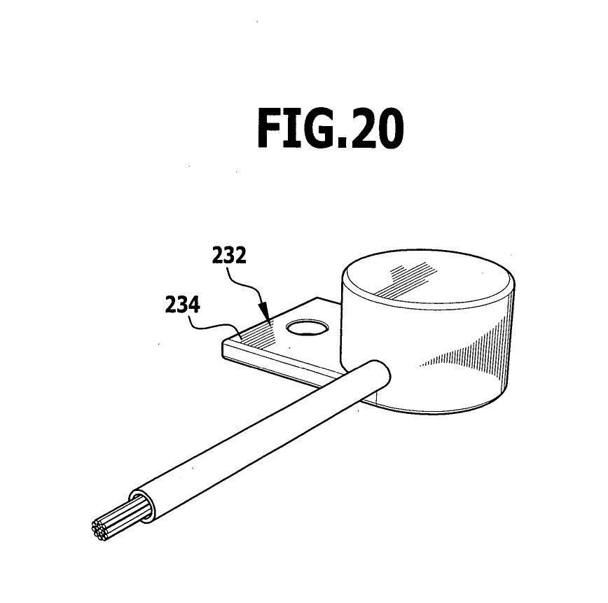

It is also possible, as shown in FIG. 20, for a holder 232 to have a flange 234 on one side, on which the housing 210 is directly seated.

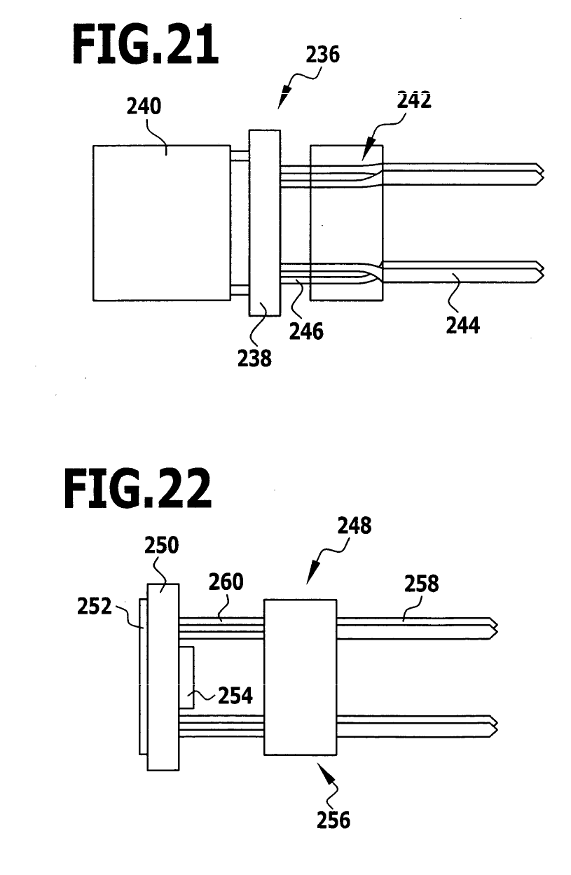

In a fifteenth embodiment of a sensor device according to the invention, which is shown in FIG. 21 (without housing) and designated as 236, a support 238 is provided, on which a coil with a coil core is seated. The combination of coil and coil core is designated in FIG. 21 with the reference numeral 240.

A plug element 242, which has a plurality of contact pins 244, is likewise seated on the support 238. The contact pins 244 point in a direction away from the coil-coil core combination 240. For example, four contact pins 244 are provided. The contact pins 244 are connected to the support 238 via contact elements 246, wherein the contact elements 246 provide for a mechanical connection and for an electrical connection. The plug element 242 is rigidly held on the support 238 via the contact elements 246.

Therefore, the (at least) one sensor element, namely the coil, and the plug element 242 are seated on the same support 238.

In a sixteenth embodiment, which is shown in FIG. 22 (without housing) and designated as 248, a support 250 is provided, on one side of which (at least) one inductive element 252 is seated. This inductive element 252 is designed as a print coil and is of a correspondingly flat design. (In FIG. 22, the height of the inductive element 252 is exaggerated for reasons of illustration).

Electronic components 254 are arranged on the oppositely located side of the support 250. For example, a chip is positioned on the support 250.

In addition, a plug element 256 is arranged on the support 250 and this has contact pins 258. The plug element 256 is seated rigidly on the support 250 via contact elements 260, wherein the contact elements 260 also provide for the electrical connection between the contact pins 258 and the support 250.

The sensor device 248 may be designed with a small height.

In accordance with the invention, sensor devices with sensor modules for connection to holding modules or with stand-alone sensor units are made available. In the case of the sensor module-holding module combination, an adaptation to a plurality of applications may be carried out without the sensor module needing to be varied. As a result, the sensor module or modules are easy to produce and have a plurality of possibilities for adaptation.

1. Sensor device, comprising:
a sensor module with a housing;
at least one sensor element arranged in the housing;
at least one active sensor face;
a sensor module connection device;
a holding module for holding the sensor module; and
a holding module connection device adapted to the sensor module connection device;
wherein the sensor module is adapted to be fixed to the holding module via the sensor module connection device and the holding module connection device and an electrical connection is made available between the sensor module and the holding module; and
wherein the holding module is provided for the fixing to an application or is part of an application, the supply of power to the sensor module is brought about via the holding module and the coupling out of signals is brought about via the holding module.

2. Sensor device as defined in claim 1, wherein the sensor module connection device and the holding module connection device are designed such that the sensor module is adapted to be plugged into the holding module.

3. Sensor device as defined in claim 1, wherein the sensor module connection device has at least one pin and the holding module connection device has an adapted pin receiving means.

4. Sensor device as defined in claim 1, wherein the holding module connection device has at least one pin and the sensor module connection device has at least one adapted pin receiving means.

5. Sensor device as defined in claim 3, wherein the at least one pin is designed as a contact pin.

6. Sensor device as defined in claim 3, wherein at least two pins are provided.

7. Sensor device as defined in claim 1, wherein the holding module has a mounting device for fixing it to an application.

8. Sensor device as defined in claim 7, wherein the mounting device comprises at least one continuous recess.

9. Sensor device as defined in claim 8, wherein a direction of orientation of the at least one recess is parallel to a plug-in direction of the sensor module onto the holding module.

10. Sensor device as defined in claim 8, wherein a direction of orientation of the at least one recess is transverse to a plug-in direction of the sensor module onto the holding module.

11. Sensor device as defined in claim 7, wherein the mounting device comprises a thread.

12. Sensor device as defined in claim 7, wherein the mounting device comprises a clampable element and/or at least one clamping element.

13. Sensor device as defined in claim 7, wherein the mounting device comprises a bar.

14. Sensor device as defined in claim 1, wherein the holding module is designed in several parts, wherein a first part is adapted to be fixed to an application and a second part is adapted to be fixed to the first part.

15. Sensor device as defined in claim 1, wherein the at least one active sensor face is parallel to a mounting side of the holding module.

16. Sensor device as defined in claim 1, wherein the at least one active sensor face is transverse to a mounting side of the holding module.

17. Sensor device as defined in claim 1, wherein a plug-in direction of the sensor module onto the holding module is transverse to a mounting side of the holding module on an application.

18. Sensor device as defined in claim 1, wherein a plug-in direction of the sensor module onto the holding module is parallel to a mounting side of the holding module on an application.

19. Sensor device as defined in claim 1, wherein the holding module and the sensor module are designed such that the sensor module projects beyond an outer surface of the holding module when it is held on the holding module.

20. Sensor device as defined in claim 1, wherein the holding module and the sensor module are designed such that the sensor module is flush with an outer surface of the holding module or is set back in relation to it when it is held on the holding module.

21. Sensor device as defined in claim 1, wherein the holding module has a signal connection and electrical connection.

22. Sensor device as defined in claim 21, wherein a cable is guided away from the holding module.

23. Sensor device as defined in claim 1, wherein the holding module is a printed circuit board.

24. Sensor device as defined in claim 1, wherein a height of the housing of the sensor module is at the most twice as great as the greatest diameter at right angles to the height.

25. Sensor device as defined in claim 1, wherein the housing of the sensor module is cylindrical or of a parallelepiped shape.

26. Sensor device as defined in claim 1, wherein the at least one active sensor face is determined by a housing side of the sensor module.

27. Sensor device as defined in claim 26, wherein the at least one active sensor face is determined by a housing side located opposite the sensor module connection device.

28. Sensor device as defined in claim 26, wherein the at least one active sensor face is located transversely to a housing side, the sensor module connection device being arranged on said housing side.

29. Sensor device as defined in claim 1, wherein the at least one sensor element is an inductive sensor element or capacitive sensor element.

30. Sensor device as defined in claim 29, wherein the at least one sensor element is a coil, a coil core being associated with said coil.

31. Sensor device as defined in claim 1, said device being designed as a distance sensor device or position sensor device or proximity sensor device or tracer device.

32. Sensor device as defined in claim 1, wherein the sensor module has a support oriented essentially parallel to the at least one sensor element.

33. Sensor device as defined in claim 32, wherein the at least one sensor element is plugged into the support or soldered to it or imprinted on it.

34. Sensor device as defined in claim 32, wherein a space is formed between the at least one sensor element and the support.

35. Sensor device as defined in claim 34, wherein one or several electronic components are arranged in the space.

36. Sensor device as defined in claim 32, wherein the support is arranged parallel to a housing side of the housing of the sensor module.

37. Sensor device as defined in claim 32, wherein the support is arranged parallel to an active sensor face.

38. Sensor device as defined in claim 24, wherein contact pins are arranged on at least one of a support and the housing.

39. Inductive sensor device with a sensor unit, comprising:
a coil as sensor element; and
a housing, the coil being arranged in said housing;
wherein the housing has a first housing end side and an active sensor face being determined by said end side;
wherein the housing has an oppositely located second housing end side; and
wherein a signal connection and a power supply connection are arranged on a housing lateral side between the first housing end side and the second housing end side.

40. Inductive sensor device as defined in claim 39, wherein the housing is closed.

41. Inductive sensor device as defined in claim 39, wherein a cable is connected to the housing lateral side.

42. Inductive sensor device as defined in claim 39, wherein a height of the housing is at the most twice as great as the greatest diameter of the housing at right angles to the height.

43. Inductive sensor device as defined in claim 39, wherein the housing is cylindrical or parallelepiped in shape.

44. Inductive sensor device as defined in claim 39, wherein a coil core is associated with the coil.

45. Inductive sensor device as defined in claim 39, wherein a support is arranged in the housing, said support being oriented essentially parallel to the first housing end side.

46. Inductive sensor device as defined in claim 45, wherein the coil is attached to the support or soldered to it or imprinted on it.

47. Inductive sensor device as defined in claim 45, wherein a space is formed between the coil and the support.

48. Inductive sensor device as defined in claim 47, wherein one or several electronic components are arranged in the space.

49. Inductive sensor device as defined in claim 45, wherein the support is oriented parallel to the first housing end side.

50. Inductive sensor device as defined in claim 39, comprising a holder adapted to be fixed to an application, wherein the housing is adapted to be fixed to the holder.

51. Inductive sensor device as defined in claim 50, wherein the holder has a space for receiving the housing.

52. Inductive sensor device with a sensor unit, comprising:
a housing; and
at least one inductive sensor element arranged in the housing;
wherein a height of the housing is at the most twice as great as the greatest diameter at right angles to the height.

53. Inductive sensor device as defined in claim 52, wherein the housing is cylindrical or parallelepiped in shape.

54. Inductive sensor device as defined in claim 52, wherein an active sensor face is determined by a housing side.

55. Inductive sensor device as defined in claim 52, wherein a coil core is associated with the at least one inductive sensor element.

56. Inductive sensor device as defined in claim 52, said sensor device being designed as a distance sensor device or position sensor device or proximity sensor device or tracer device.

57. Inductive sensor device as defined in claim 52, wherein a support is provided, said support being oriented essentially parallel to the at least one inductive sensor element.

58. Inductive sensor device as defined in claim 57, wherein the at least one inductive sensor element is plugged into the support or soldered to it or imprinted on it.

59. Inductive sensor device as defined in claim 57, wherein a space is formed between the at least one inductive sensor element and the support.

60. Inductive sensor device as defined in claim 59, wherein one or several electronic components are arranged in the space.

61. Inductive sensor device as defined in claim 57, wherein the support is arranged parallel to a housing side of the housing.

62. Inductive sensor device as defined in claim 57, wherein the support is arranged parallel to an active sensor face.

63. Inductive sensor device as defined in claim 52, wherein contact pins are arranged on at least one of a support and the housing.

64. Inductive sensor device as defined in claim 57, wherein a plug element is arranged on the support.

65. Inductive sensor device as defined in claim 64, wherein the plug element is connected rigidly to the support.

66. Inductive sensor device as defined in claim 64, wherein the plug element has contact pins.

67. Inductive sensor device as defined in claim 52, wherein the at least one inductive element is arranged on one side of the support and electronic components are arranged on the oppositely located side of the support.
